(19) United States
(12) Patent Application Publication
(10) Pub. No.: US 2010/0287987 A1
(43) Pub. Date: Nov. 18, 2010

(54) Massaging nursing bracelet - the chicminder

(76) Inventors: Adam Zeidel, New York, NY (US); Leigh Osofsky, New York, NY (US)

Correspondence Address: Adam Zeidel, 415 Grand St. #E1907, New York, NY, 10002, US

(21) Appl. No.: 12/583,071

(22) Filed: Aug. 14, 2009

Related U.S. Application Data
(60) Provisional application No. 61/216,120, filed on May 14, 2009.

(51) Int. Cl. A44C 5/00; A44C 9/00; G09F 9/00; A61H 15/00

(52) U.S. Cl. 63/1.11; 63/3; 63/15; 116/306; 601/112

(57) ABSTRACT

A nursing cuff that can be moved easily back and forth from the right to left wrist as a result of its contractible nature and a permanent opening, allowing the nursing mother to keep track of which breast she last used to feed her baby. The cuff is made of a durable, waterproof, non-toxic material and expands and contracts to conform to the nursing mother's wrist. The cuff also serves as a baby massager, which calms both baby and mother before, during, and after feedings.

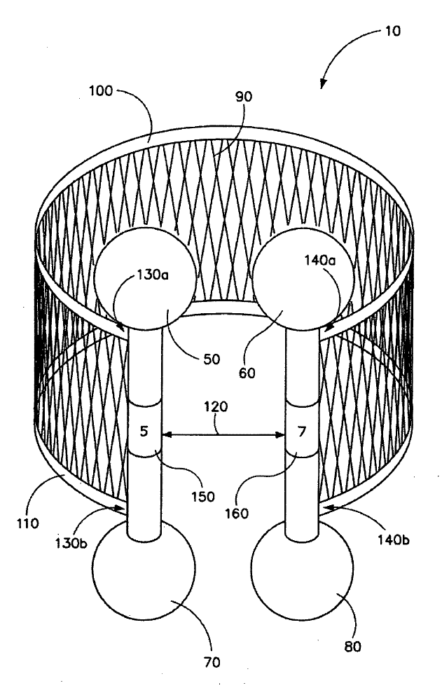

### CROSS-REFERENCE TO RELATED APPLICATIONS

This application claims the benefit of provisional application No. 61/216,120 (date: May 14, 2009).

### STATEMENT REGARDING FEDERALLY SPONSORED RESEARCH OR DEVELOPMENT

Not Applicable.

### REFERENCE TO SEQUENCE LISTING, A TABLE, OR A COMPUTER PROGRAM LISTING COMPACT DISC APPENDIX

Not Applicable.

### BACKGROUND OF THE INVENTION

1. Field of Invention

This invention relates to the field of bracelets and wristbands, to devices used to monitor breastfeeding, and to massagers and vibrators.

2. Background of the Invention

Unlike in previous generations, breastfeeding is now strongly advised by the medical community. The American Academy of Pediatrics now recommends exclusive breastfeeding for six months and continuation of breastfeeding for one year and beyond. Many pediatricians and nutritional experts believe that breastfeeding provides both baby and mother with invaluable health, physiological, and psychological benefits. See Kathleen Huggins, The Nursing Mother's Companion (Boston: The Harvard Common Press, 2005); William Sears and Martha Sears, The Baby Book (New York: Little, Brown and Company, 2003).

However, nursing mothers face many challenges to successful breastfeeding. A new mother may face practical and physical challenges, such as difficulties with developing a proper latch onto the breast, supply problems, and breast infection. These problems are compounded when the infant has difficulty breastfeeding for a variety of reasons, such as a tongue-tie, a high palate, a sucking problem, or a medical ailment. The historical aversion to breastfeeding in western cultures makes the breastfeeding mother's role more difficult still, because many women do not have familial breastfeeding experience or support. While societal support for breastfeeding is crucial for nursing mothers to succeed, many women still feel uncomfortable about their breastfeeding as a result of perceived lack of acceptance. Breastfeeding mothers also have to contend with fatigue, which exacerbates all of the above problems, and makes simplicity and ease of use crucial to any device designed to aid breastfeeding mothers.

Breastfeeding experts and experienced nursing mothers alike recommend switching from one breast to another while breastfeeding in order to develop and maintain adequate milk supply and protect the nursing mother from clogged ducts and engorgement.

Pediatricians now also widely recommend infant massage as a way to calm both mother and baby, develop essential connections between the two, and stimulate infant growth and development. For example, baby expert Dr. William Sears recommends infant massage as a means to relax mother and baby, allowing the mother's hormones to flow, and enabling successful breastfeeding. William Sears and Martha Sears, The Baby Book (New York: Little, Brown and Company, 2003), 145.

As a result of the above described set of circumstances, there is a need for a breastfeeding cuff that: (1) reminds the mother of which breast was last used to feed the infant, (2) massages both mother and baby, and (3) safely serves as a stylish point of pride to encourage the breastfeeding mother.

3. Prior Art

Prior art exists that a breastfeeding mother can use as a reminder system.

U.S. Pat. No. D415,976, “Reminder Bracelet”, is an instrument used by the mother to keep track of breastfeeding data. However, the device does not have any massaging function.

Canadian Patent No. 2177291 is an indicator for a breastfeeding mother to keep track of right or left breast while breastfeeding. However, this device is designed to be hidden from view (on mother's bra) and does not have any massaging function.

U.S. Pat. No. 7,313,929, “Wearable Record Tracking Device and Method of Using” (“The Nursing Bracelet”), employs a beaded system to provide a breastfeeding mother with a reminder device that also keeps track of breastfeeding data. However, the bead and charm design used in this device presents a potential choking hazard for babies. Furthermore, this device has no massaging function. Finally, this device has no simple “right” versus “left” indicator on the device itself and instead relies on a complicated data system which obscures the most important element of a breastfeeding reminder system—the side of the body from which the mother should next be feeding the baby.

Other patents (such as U.S. Pat. Nos. 4,423,734 (bra with slidable indicator); 5,092,812 (bra with nursing sequence indicator in the cups); 6,364,739 (indicator worn on bra); 4,972,391 (resettable electronic breastfeeding timer with visual display)) present mother-reminder systems that the mother does not wear on her wrist and that have no massaging function.

U.S. Pat. No. D505,353, “Mothers Minder Reminder Bracelet”, is a breastfeeding reminder bracelet relying on a slider system to keep track of breastfeeding data. But, this device has no simple “right” versus “left” indicator on the device itself and instead relies on a complicated data system which obscures the most important element of a breastfeeding reminder system—the side of the body from which the mother should next be feeding the baby. Additionally, this device has no massaging function.

Additionally, prior art exists which contemplates a wrist massage device (example: U.S. Pat. No. 5,575,761). However, none of these devices have applications to breastfeeding, do not remind a breastfeeding mother which breast was last used to feed an infant, and do not safely serve as a stylish point of pride to encourage a breastfeeding mother.

Therefore, there is a need for a breastfeeding cuff that: (1) reminds the mother of which breast was last used to feed the infant, (2) massages both mother and baby, and (3) safely serves as a stylish point of pride to encourage the breastfeeding mother.

### BRIEF SUMMARY OF THE INVENTION

### Summary of the Invention

The present invention is a nursing cuff that the mother can easily move from wrist to wrist to keep track of which breast she last fed from. After the mother feeds the baby, she can easily move the cuff to that wrist to remember that this is the breast she last fed from.

The cuff also functions as a massager. In one preferred embodiment, the massaging element is comprised of a system in which an object rolls around an axis. In this preferred embodiment, the cuff wraps around the mother's wrist but does not close completely. It remains open one-half inch. On either side of this one-half inch of open space, the cuff gathers into two bead-like forms, at the top of the cuff and at the bottom of the cuff, on each side of the opening. As a result, there are four bead-like forms abutting the open space of the cuff. These allow the mother to easily run the bead-like forms up and down the baby's back before, during, and after feeding, providing calming massage for both mother and baby. The layout of the bead-like forms allows the mother to rub the baby's back up and down while her arm is in a horizontal position (while nursing) or while her arm is in a vertical position (at other times). In another preferred embodiment, the cuff may also have a vibrating component to calm both mother and baby. In this preferred embodiment, the massaging element is comprised of an electric motor system.

The cuff is waterproof, non-toxic, and not a choking hazard so that the mother never has to remove it while showering and can always use it around her baby without worry. In one preferred embodiment, the cuff is intricately laced into a tight mesh design, allowing breathability for every day use and comfort, while maintaining a stylish design.

The cuff is designed so that it serves not only a utilitarian purpose, but also is a stylish symbol of the nursing mother's pride in her accomplishment in breastfeeding her child. In one preferred embodiment, the cuff can expand or contract so that it conforms to the nursing mother's wrist. This fulfills all of the purposes of the breastfeeding cuff because the contractibility allows the cuff to: (1) move back and forth easily from one wrist to another, (2) snugly fit each nursing mother so that the massaging elements rub the inside of her wrist while she runs the cuff up and down the baby's back, thereby relaxing her as she massages her baby, and (3) stylishly and individually fit each nursing mother.

### BRIEF DESCRIPTION OF THE SEVERAL VIEWS OF THE DRAWING

### Brief Description of the Drawings

The FIGURE is the cuff of the present invention.

### DETAILED DESCRIPTION OF THE INVENTION

### Detailed Description of the Preferred Embodiments

With reference to the drawing wherein the same reference number illustrates the same element throughout, the FIGURE shows a cuff 10 of the present invention. The cuff may be annularly shaped. Cuff 10 may comprise four bead-like forms (50, 60, 70, and 80), two each on either side of an open space one-half inch wide (120), which are the ends of an intricately laced nursing cuff. Alternatively, the bead-like forms may all sit on one side of the open space or there may be more on one side than on the other. Also, there may be a different number of bead-like forms coupled to the cuff. The bead-like forms may take any shape, including but not limited to balls, spheres, cubes, cones, tubes, and cylinders. Additionally, the open space may be of any dimension. Alternatively, there may be no open space at the base of the cuff. The interior of the nursing cuff may be an intricately-laced, cross-hatched design (90). Alternatively, the nursing cuff may be a solid design.

The outer edges of the nursing cuff (100 and 110) may be made of a durable, waterproof, non-toxic material. The inner mesh of the nursing cuff (90) may also be made of a durable, waterproof, non-toxic material, and may be thinner and more delicate in appearance than the outer edges of the nursing cuff. Alternatively, the elements of the nursing cuff may be made of a non-durable, disposable material. All of the parts of the nursing cuff may be fused together, so there are no separate pieces that could break off and create a choking hazard. The nursing cuff can come in a variety of colors, including blue, pink, light green, yellow, silver, and gold, or a combination thereof (ie: with 90 being silver and 50, 60, 70, and 80 being blue). This allows for personalization of the cuff, to reflect the mother's style and the baby's gender, if the mother wishes. The durable, waterproof, non-toxic material, which 100 and 110 may be comprised of, may expand and contract so that the nursing cuff is taut on each mother's wrist. This expansion and contraction capability, along with the flexibility of the material that comprises the cuff, allows the mother to easily move the nursing cuff from one wrist to the other by expanding the nursing cuff to remove it and then contracting it on the other wrist. The cuff may be designed so that switching the cuff from one part of the user's body to another part of the user's body may be accomplished with one hand. Alternatively, the cuff may be made of a solid, non-flexible material. In the case where the cuff is made of a solid, non-flexible material, the cuff may be taken off and put back on via a hinge in the center of the cuff that opens and closes by pulling on either side of the cuff. The cuff may be made to wear around body parts besides the wrist, as well. For example, the cuff may be made to wear around the finger, the ankle, the neck, the foot, the waist, the head, or the hand.

The FIGURE shows the inner part of the nursing cuff, which may lay underneath the mother's wrist. The bead-like forms (50, 60, 70, and 80) may surround a one-half inch square open space. The open space may constitute other shapes as well, for example a circle, rectangle, or triangle. The bead like forms are designed for a soothing massage of mother and baby, when mother runs the cuff up and down baby's back while feeding baby. The opening (120) may be designed so that the bead-like forms will run up and down either side of baby's spine and will sit on the underneath side of the mother's wrist, relaxing both through massage while feeding. The user may also massage other parts of the subject of the massage, for example the upper back, the lower back, the belly, or the feet. The bead-like forms (50, 60, 70, and 80) may be fused into the cuff ends (130a, 130b, 140a, 140b) to which they are coupled. Alternatively, the bead-like forms may be coupled to the cuff in some other manner and may move around to different positions on the cuff. As another alternative, the bead-like forms may be hollow in their interior and coupled to an axis. The bead-like forms may roll around the axis and massage the wearer of the cuff and the subject of the massage by rolling the bead-like forms around the axis and between the skin of the wearer of the device and the subject of the massage. The one-half inch square open space (120) may remain the same on every nursing mother. Alternatively, the fixed open space may be of some size other than one-half inch. As another alternative, a user may expand or contract the open space to a size different than the default to fit his or her preferences. The cuff may be made with no opening at the base of the cuff. The shape of the cuff may be variable and the open space may be able to be transformed from one shape (example: a square) to another (example: a circle). As an alternate to the cuff in which the bead-like forms manually massage the user and baby by rolling the device between the skin of the wearer of the device and the subject of the massage, the massaging function may also comprise an electric motor system. In such a scenario, the electric motor system may be triggered via a button, switch, dial, or some other instrument. In the case of the button, the user may press or otherwise touch the button, moving the button from a primary “off” position to a secondary “on” position and activating the electric motor system. In the case of the switch, the user may push or otherwise touch the switch, moving it from a primary “off” position to a secondary “on” position. In the case of the dial, the user may turn or otherwise touch the dial, moving it from a primary “off” position to a secondary “on” position. Following the trigger from “off” to “on”, the cuff would then vibrate against the user and baby, massaging both.

The FIGURE also shows the underside side of the nursing cuff, which may allow the mother to record feeding data for the baby and data for herself in an easy-to-use, safe fashion. On one side of the underside of the nursing cuff may be a small dial with numbers 0-8 (150). These numbers may represent the 8 times a day the mother is supposed to nurse or feed her newborn (with 0 representing the beginning of the day, when no feeds have occurred). Every time the mother finishes feeding her newborn, she turns the dial one notch. The dial may be turned with a finger or, alternatively, with any other touch. As a result, at the end of the day, she can take a quick look at the underside of the nursing cuff to see if she is meeting the number of feedings she should be doing in a day. At the end of the day, the mother turns the dial back to 0 and begins again. When the baby gets older and needs to nurse less frequently, the mother can start the dial at a higher number (i.e.: 3, if she wants to nurse 5 times a day), so that she can use the same system to ensure she is meeting her new nursing or feeding goal. The mother who is expressing breast milk with a breast pump can use the same system to make sure she is meeting her pumping goal. The system allows her an easy way to keep track of her pumping sessions if she is busy at work or otherwise, and the information is always available on her wrist, so she has it both when she is at work and at home. This dial may have its numbers in white (or some other color that is not the same color as the second dial, described below), so that the mother can easily identify it as the dial to keep track of the baby's feedings.

On the other side of the nursing cuff may be a second dial (160). This dial may have numbers 0-10. These numbers may represent the 10 times a day the mother is supposed to drink a glass of water. It is essential for the nursing mother's milk supply and health that she drinks at least 10 glasses of water a day. Every time the mother finishes a glass of water, she turns the dial one notch. At the end of the day, the mother turns the dial back to 0 and begins again. This essential information helps the mother nurture herself so that she can feed the baby. The mother may not feel she has the time to think about nurturing herself without this easily accessible reminder. This dial may have its numbers in dark purple (or some other color that is not the same color as the first dial, described above), so that the mother can easily identify it as the dial to keep track of her water.

The numbering corresponding to the above data may be different than that described above. Additionally, the data systems described above may take forms other than dials. For example, the data may be recorded and displayed via buttons, switches, or sliding indicators. Additionally, alternate data relevant to breastfeeding may be the subject of the data systems. For example, these data systems may relate to the time length of feedings, the volume of breast milk consumed in a feeding, or time of day of feeding. The recording and display of these alternate forms of data would require alternate numbering systems. Additionally, there may be more than two data systems coupled to the cuff. For example, there may be a data system that indicates “right” versus “left” (as in, which breast the mother has used to last feed the baby). The “right” versus “left” data may be recorded and displayed via a button, switch, or sliding indicator. In the case of the button, the button may appear in the primary, non-depressed position to indicate one form of binary information (i.e. “right”) and could depress via a touch to a secondary position to indicate the other form of binary information (i.e. “left”) and via the same touch back to the primary position. In the case of the switch, the touch of the user could move the switch from a primary position (i.e. “right”) to a secondary position (i.e. “left”) and back to the primary position. In the case of the sliding indicator, the indicator could be a square-shaped form with a hole in the middle that the user could slide back-and-forth over a set of symbols to indicate some breastfeeding-related information. For example, the user could slide the form over an “R” to indicate that the mother has last fed the baby from the right breast and then slide the form over an “L” to indicate that the mother has last fed the baby from the left breast. The sliding indicator need not be square shaped and could be a circle, triangle, rectangle, or any other shape. Furthermore, the sliding indicator need not have a hole in the middle and could be solid and/or clear. The above data systems may be located in other locations on the cuff and are not confined to the underside of the cuff.

The FIGURE shows the inner mesh of the nursing cuff. The inner mesh of the nursing cuff may be intricately laced in a cross-hatch form to allow for breathability (90). It may be thinner than the outer edges of the nursing cuff (100 and 110) to which it is attached. All parts may be completely fused together. 100 and 110 may be flexible, to allow for expansion or contraction to fit the mother's wrist. Alternatively, the inner mesh may be a solid form or thicker than the outer edges of the cuff or the parts may be coupled to each other in some other fashion than being fused together (example: connected to each other). The cuff may also be non-flexible.

While the invention has been described and illustrated with reference to specific embodiments, it is to be distinctly understood that this invention is not limited thereto but may be variously embodied to practice within the scope of the following claims.

What is claimed is:

1. A wearable device comprising:
a) a cuff;
b) at least one instrument disposed on the cuff capable of indicating data that assists a user of the device in breastfeeding; and
b) at least one massaging element coupled to the cuff.

2. The device of claim 1 wherein the instrument capable of indicating data comprises an element that is capable of moving back and forth to indicate right versus left.

3. The device of claim 1 wherein the instrument capable of indicating data comprises a button capable of being depressed to indicate right versus left.

4. The device of claim 1 wherein the massaging element comprises an electric motor system.

5. The device of claim 1 wherein the massaging element comprises a system in which an object rolls around an axis.

6. The device of claim 1 wherein the cuff is made of a flexible material.

7. The device of claim 1 wherein the cuff is made of a water-safe material.

8. The device of claim 1 wherein the massaging element is triggered when the device is rolled between the skin of the wearer of the device and the subject of the massage.

9. The device of claim 1 further comprising a button wherein the massaging element is triggered when the button is pressed.

10. The device of claim 1 further comprising a switch wherein the massaging element is triggered when the switch is flipped.

11. The device of claim 1 further comprising a dial wherein the massaging element is triggered when the dial is turned.

12. The device of claim 1 wherein the instrument comprises a plurality of dials that are capable of recording data relevant to breastfeeding.

13. The device of claim 12 wherein the plurality of dials are further capable of indicating whether a task has or has not been completed.

14. The device of claim 1 wherein the device is capable of being worn around the wrist.

15. The device of claim 1 wherein the device is capable of being worn around a finger.

16. The device of claim 1 wherein the cuff comprises a cross-hatch design allowing breathability for every day use and comfort.

17. The device of claim 1 wherein the cuff comprises an expanding and contracting design so that the cuff is capable of conforming to the user's wrist.

18. The device of claim 1 wherein the cuff comprises a flexible material so that the cuff is capable of being switched with one hand from one part of the user's body to another part of the user's body.

19. The device of claim 1 wherein the cuff is annularly shaped.

20. The device of claim 19 wherein the annularly shaped cuff remains open, causing the cuff to have two opposite ends.

21. The device of claim 20 wherein the massaging element comprises bead-like forms disposed on these opposite ends.
